(19) United States
(12) Patent Application Publication
(10) Pub. No.: US 2023/0352659 A1
(43) Pub. Date: Nov. 2, 2023

(54) COMPOSITE PARTICLES FOR NON-AQUEOUS ELECTROLYTE RECHARGEABLE BATTERY, PRODUCING METHOD, POSITIVE AND NEGATIVE ELECTRODES, AND NON-AQUEOUS ELECTROLYTE RECHARGEABLE BATTERY

(71) Applicant: SAMSUNG SDI CO., LTD., Yongin-si (KR)

(72) Inventors: Jinseok BAEK, Yokohama-shi (JP); Tomoyuki FUKATANI, Yokohama-shi (JP)

(21) Appl. No.: 18/193,579

(22) Filed: Mar. 30, 2023

(30) Foreign Application Priority Data
Mar. 31, 2022 (JP) 2022-059554
Mar. 30, 2023 (KR) 10-2023-0041914

(51) Int. Cl. H01M 4/36; H01M 4/04; H01M 4/485

(52) U.S. Cl. CPC H01M 4/364; H01M 4/0471; H01M 4/485; H01M 2004/021

(57) ABSTRACT

The composite particles for a non-aqueous electrolyte rechargeable battery are surface-treated composite particles including metal hydroxide particles and conductive particles, wherein a volume resistivity of the composite particles at the time of about 60 MPa pressurization is greater than or equal to about 0.10 Ωcm and less than or equal to about 4 × 10⁴ Ωcm, an endothermic amount of the composite particles between about 50° C. to about 250° C. in differential scanning calorimetry is greater than or equal to about 150 J/g and less than or equal to about 500 J/g, and an amount of desorbed P₂ (MS1) of the composite particles from about 80° C. to about 1400° C. by thermal desorption gas mass spectrometry (TDS-MS) is greater than or equal to about 300 × 10⁻⁶ mol/g and less than or equal to about 3000 × 10⁻⁶ mol/g.

### CROSS-REFERENCE TO RELATED APPLICATION

This application claims priority to and the benefit of Japanese Patent Application No. 2022-059554 filed in the Japan Patent Office on Mar. 31, 2022, and Korean Patent Application No. 10-2023-0041914 filed in the Korean Intellectual Property Office on Mar. 30, 2023, the entire content of each of which is incorporated herein by reference.

### BACKGROUND

### 1. Field

One or more embodiments of the present disclosure relate to composite particles for a non-aqueous electrolyte rechargeable battery, a method of producing the same, positive and negative electrodes, and a non-aqueous electrolyte rechargeable battery.

### 2. Description of the Related Art

Non-aqueous electrolyte rechargeable batteries including rechargeable lithium ion batteries are widely utilized as power sources for smart phones, notebook computers, and/or the like, and recently are also utilized for large-sized batteries such as those for vehicles (e.g., electric vehicles).

The rechargeable lithium ion batteries have advantages of high energy density, but because they utilize non-aqueous electrolytes, sufficient measures are desired or required for safety. However, with the increase in the size of batteries, securing safety has become more important.

For example, when a rechargeable lithium ion battery is placed in a high-temperature environment, there is a possibility that the positive electrode of the rechargeable lithium ion battery generates heat and the internal temperature of the battery rises. When the internal temperature becomes high, a short circuit due to shrinkage of the separator included in the rechargeable lithium ion battery is likely to occur. As a result, there is a possibility that the internal temperature may further rise.

Therefore, in order to ensure the safety of the rechargeable lithium ion battery, it has been proposed to include inorganic particles composed of metal hydroxide particles having heat-absorption properties as endothermic particles in the rechargeable lithium ion battery to suppress or reduce an increase in internal temperature of the rechargeable lithium ion battery.

For example, a first proposal proposes that inorganic particles composed of endothermic and basic calcium silicate having a specific surface area ratio by adsorption of water vapor and nitrogen gas of greater than or equal to about 0.45 and less than or equal to about 2.0 may be included in a separator as endothermic particles to improve battery safety.

In addition, a second proposal proposes that aluminum hydroxide particles having a maximum endothermic peak temperature in a differential scanning calorimetry method (DSC) of greater than or equal to about 270° C. and less than or equal to about 360° C., and a dehydration reaction temperature range of greater than or equal to about 200° C. and less than or equal to about 400° C. may be included in an electrolyte or separator.

### SUMMARY

However, according to the study of the present inventors, it is known that there are cases where the internal temperature of the non-aqueous electrolyte rechargeable battery cannot be sufficiently suppressed or reduced by the inorganic particles described in the first proposal.

Also, in the temperature ranges described in the second proposal, melting of the separator included in the non-aqueous electrolyte rechargeable battery and decomposition of the charged positive electrode occur.

In addition, when inorganic particles described in first and second proposals are included in the positive electrode or negative electrode of a non-aqueous electrolyte rechargeable battery, a volume resistivity of these inorganic particles is large, and thus electrical resistance of the non-aqueous electrolyte rechargeable battery as a whole may increase.

The present disclosure has been made in view of the above-described problems, and provides composite particles capable of suppressing an increase in the internal temperature of a non-aqueous electrolyte rechargeable battery even under an environment in which the internal temperature is likely to increase due to battery abnormalities such as internal short circuits and capable of suppressing or reducing the electrical resistance of a non-aqueous electrolyte rechargeable battery to a low level.

One or more aspects of embodiments of the present disclosure are directed toward composite particles for a non-aqueous electrolyte rechargeable battery. The composite particles may include metal hydroxide particles and conductive particles,
wherein a volume resistivity of the composite particles at the time of about 60 MPa pressurization is greater than or equal to about 0.10 Ωcm and less than or equal to about 4 × 10⁴ Ωcm,
an endothermic amount of the composite particles between about 50° C. to about 250° C. in differential scanning calorimetry is greater than or equal to about 150 J/g and less than or equal to about 500 J/g, and
an amount of desorbed P₂ (i.e., diphosphorus) (MS1) of the composite particles from about 80° C. to about 1400° C. by thermal desorption gas mass spectrometry (TDS-MS) is greater than or equal to about 300 × 10⁻⁶ mol/g and less than or equal to about 3000 × 10⁻⁶ mol/g.

According to the composite particles for the non-aqueous electrolyte rechargeable battery configured as described above, because a degree of modification by phosphonic acid, which is defined by a desorbed amount of P₂ gas, is set within an appropriate or suitable range, an increase in the internal temperature of non-aqueous electrolyte rechargeable battery including the composite particle can be suppressed or reduced sufficiently.

In one or more embodiments, because the volume resistivity of the composite particles at the time of about 60 MPa pressurization is greater than or equal to about 0.10 Ωcm and less than or equal to about 4 × 10⁴ Ωcm, even when these composite particles are included in the positive electrode and/or the negative electrode, electrical resistance of the non-aqueous electrolyte rechargeable battery may be reduced to a low level.

In one or more embodiments, the amount of desorbed H₂O (MS2) of the composite particles from about 80° C. to about 200° C. as determined by a thermal desorption gas mass spectrometry (TDS-MS) may be greater than or equal to about 30 × 10⁻⁶ mol/g and less than or equal to about 1500 × 10⁻⁶ mol/g, and a desorption gas amount ratio (MS1/MS2) may satisfy Formula (1).

$$0.5 \leq \left(\text{MS1} / \text{MS2}\right) \leq 5.0 \qquad \text{(1)}$$

In one or more embodiments, a ratio (A_{D} / A_{G}) of a peak area (A_{D}) around 1350 cm⁻¹ and a peak area (A_{G}) around 1580 cm⁻¹ measured by Raman spectroscopy of the composite particles may be greater than or equal to about 0.5 and less than or equal to about 3.5, and

a peak full width at half maximum (G′-FWHM) around 2680 cm⁻¹ measured by Raman spectroscopy may be greater than or equal to about 60 cm⁻¹ and less than or equal to about 150 cm⁻¹.

In one or more embodiments, a specific surface area (BET1) of the composite particles calculated based on an adsorption isotherm measured by adsorbing water vapor may be greater than or equal to about 8 m²/g and less than or equal to about 600 m²/g, and

a specific surface area (BET2) of the composite particles calculated based on an adsorption isotherm measured by adsorbing nitrogen may be greater than or equal to about 8 m²/g and less than or equal to about 600 m²/g.

In one or more embodiments, a specific surface area ratio (BET1/BET2) may satisfy Formula (2).

$$0.2 \leq \left(\text{BET1} / \text{BET2}\right) \leq 5.0 \qquad \text{(2)}$$

In one or more embodiments, an amount of desorbed CH₄ (MS3) of the composite particles from about 80° C. to about 1400° C. by thermal desorption gas mass spectrometry (TDS-MS) may be greater than or equal to about 30 × 10⁻⁶ mol/g and less than or equal to about 1000 × 10⁶ mol/g, and

an amount of desorbed CH₃OH (MS4) of the composite particles from about 80° C. to about 1400° C. by TDS-MS may be greater than or equal to about 10 × 10⁻⁶ mol/g and less than or equal to about 3000 × 10⁻⁶ mol/g.

In one or more embodiments, an amount of desorbed C₆H₆ (MS5) of the composite particles from about 80° C. to about 1400° C. by TDS-MS may be greater than or equal to about 1 × 10⁻⁶ mol/g and less than or equal to about 4000 × 10⁻⁶ mol/g.

In one or more embodiments, the metal hydroxide may be at least one selected from aluminum hydroxide, pseudo-boehmite, boehmite, alumina, or kaolinite.

One or more aspects of embodiments of the present disclosure are directed toward a positive electrode or a negative electrode for a non-aqueous electrolyte rechargeable battery containing the above-described composite particles for a non-aqueous electrolyte rechargeable battery in an amount of greater than or equal to about 0.1 wt% and less than or equal to about 5.0 wt% based on the total weight of a positive or negative electrode mixture layer of the positive or negative electrode, respectively, and in one or more embodiments, a non-aqueous electrolyte rechargeable battery having these positive electrodes or negative electrodes may also be provided.

According to the composite particles for a non-aqueous electrolyte rechargeable battery according to one or more embodiments of the present disclosure, an endothermic amount at about 50° C. to about 250° C. is greater than or equal to about 150 J/g and less than or equal to about 500 J/g, and a degree of modification by phosphonic acid is set to an appropriate or suitable range. As a result, an increase in the internal temperature of the non-aqueous electrolyte rechargeable battery including the composite particles may be sufficiently suppressed or reduced even under an environment in which the internal temperature tends to increase due to a battery abnormality such as an internal short circuit.

As a result, deterioration of the battery caused by an increase in the internal temperature of the non-aqueous electrolyte rechargeable battery may be suppressed or reduced, and cycle life of the non-aqueous electrolyte rechargeable battery may be improved.

In addition, when the volume resistivity of the composite particle is greater than or equal to about 0.10 Ωcm and less than or equal to about 4 × 10⁴ Ωcm, the composite particles may be utilized as an endothermic conductive agent having properties as a conductive agent as well as endothermic property.

As a result, the electrical resistance of the non-aqueous electrolyte rechargeable battery may be suppressed or reduced to a low level even when the composite particles according to the present disclosure may be included in the positive electrode or the negative electrode.

Additional aspects will be set forth in part in the description which follows and, in part, will be apparent from the description, or may be learned by practice of the presented embodiments of the disclosure.

### BRIEF DESCRIPTION OF THE DRAWINGS

The accompanying drawing is included to provide a further understanding of the present disclosure, and is incorporated in and constitutes a part of this specification. The drawing illustrates example embodiments of the present disclosure and, together with the description, serve to explain principles of present disclosure. In the drawing:

FIG. 1 is a schematic view illustrating a non-aqueous electrolyte rechargeable battery according to one or more embodiments of the present disclosure; and

FIG. 2 is a schematic view showing the structure of a composite particle according to one or more embodiments of the present disclosure.

### DETAILED DESCRIPTION

The present disclosure may be modified in many alternate forms, and thus specific embodiments will be exemplified in the drawing and described in more detail. It should be understood, however, that it is not intended to limit the present disclosure to the particular forms disclosed, but rather, is intended to cover all modifications, equivalents, and alternatives falling within the spirit and scope of the present disclosure.

Hereinafter, a non-aqueous electrolyte rechargeable battery according to one or more embodiments will be described in more detail.

### 1. Basic Configuration of Non-aqueous Electrolyte Rechargeable Battery

The non-aqueous electrolyte rechargeable battery according to one or more embodiments of the present disclosure is a rechargeable lithium ion battery including a positive electrode, a negative electrode, a separator, and a non-aqueous electrolyte.

The shape of the rechargeable lithium ion battery is not particularly limited, but may be, for example, a cylindrical shape, a prismatic shape, a laminated shape, or a button shape.

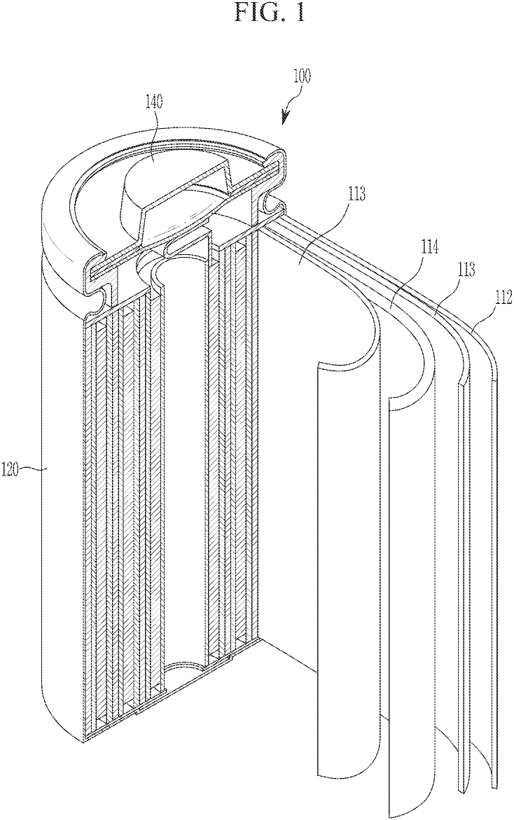

Hereinafter, a non-aqueous electrolyte rechargeable battery according to one or more embodiments will be described with reference to FIG. 1. FIG. 1 is a schematic view illustrating a non-aqueous electrolyte rechargeable battery according to one or more embodiments of the present disclosure. Referring to FIG. 1, a rechargeable lithium battery 100 according to one or more embodiments of the present disclosure may include a battery cell including a positive electrode 114, a negative electrode 112 facing the positive electrode 114, a separator 113 between the positive electrode 114 and the negative electrode 112, and a non-aqueous electrolyte for a rechargeable lithium battery impregnating the positive electrode 114, negative electrode 112, and separator 113, a battery case 120 housing the battery cell, and a sealing member 140 sealing the battery case 120.

### 1-1. Positive Electrode

The positive electrode may include a positive electrode current collector and a positive electrode mixture layer formed on the positive electrode current collector. The positive electrode current collector may be any material (any suitable material) as long as it is a conductor, and may be, for example, plate-shaped or thin, and may be desirably made of aluminum, stainless steel, nickel coated steel, and/or the like.

The positive electrode mixture layer may include at least a positive electrode active material, and may further include a conductive agent and a positive electrode binder.

The positive electrode active material may be, for example, a transition metal oxide or a solid solution oxide including lithium, and is not particularly limited as long as it may electrochemically intercalate and deintercalate lithium ions. Non-limiting examples of the transition metal oxide including lithium may include Li_{1.0}Ni_{0.88}Co_{0.1}Al_{0.01}Mg_{0.01}O₂, etc. In some embodiments, Li·Co composite oxides such as LiCoO₂ and Li·Ni·Co—Mn—based composite oxides such as LiNiₓCo_{y}Mn_{z}O₂, Li—Ni—based composite oxide such as LiNiO₂, or Li-Mn-based composite oxides such as LiMn₂O₄, and/or the like may be utilized as the positive electrode active material. Non-limiting examples of the solid solution oxide including lithium may include LiₐMnₓCo_{y}NizO₂ (1.150 ≤ a ≤ 1.430, 0.45 ≤ × ≤ 0.6, 0.10 ≤ y ≤ 0.15, 0.20 <_ z ≤ 0.28), LiMn_{1.5}Ni_{0.5}O₄. A content (e.g., amount) (content (e.g., amount) ratio) of the positive electrode active material is not particularly limited, as long as it is applicable to the positive electrode mixture layer of a non-aqueous electrolyte rechargeable battery. Moreover, these compounds may be utilized alone or may be utilized in mixture of plural types (kinds).

The conductive agent is not particularly limited as long as it is for increasing the conductivity of the positive electrode. Non-limiting examples of the conductive agent may include those including at least one selected from among carbon black, natural graphite, artificial graphite, fibrous carbon, and sheet-like carbon.

Non-limiting examples of the carbon black may include furnace black, channel black, thermal black, ketjen black, and/or acetylene black.

Non-limiting examples of the fibrous carbon may include carbon nanotubes and/or carbon nanofibers, and non-limiting examples of the sheet-like carbon may include graphene and/or the like.

A content (e.g., amount) of the conductive agent in the positive electrode mixture layer is not particularly limited, but may be greater than or equal to about 0.1 wt% and less than or equal to about 5 wt%, or greater than or equal to about 0.5 wt% and less than or equal to about 3 wt% based on the total amount of the positive electrode mixture layer, from the viewpoint of achieving both (e.g., simultaneously) conductivity and battery capacity.

The positive electrode binder may include, for example, a fluoro-containing resin such as polyvinylidene fluoride, an ethylene-containing resin such as styrene-butadiene rubber, an ethylene-propylene diene terpolymer, an acrylonitrile-butadiene rubber, a fluoro rubber, polyvinyl acetate, polymethylmethacrylate, polyethylene, polyvinyl alcohol, carboxymethyl cellulose, a carboxymethyl cellulose derivative (a salt of carboxymethyl cellulose, etc.), nitrocellulose, and/or the like. The positive electrode binder may be any material capable of binding the positive electrode active material and the conductive agent onto the positive electrode current collector, and embodiments of the present disclosure are not particularly limited thereto.

### 1-2. Negative Electrode

A negative electrode may include a negative current collector and a negative electrode mixture layer formed on the negative current collector.

The negative current collector may be anything as long as it is a conductor, and may be desirably plate-shaped or thin, and made of copper, stainless steel, nickel-plated steel, and/or the like.

The negative electrode mixture layer may include at least a negative electrode active material, and may further include a conductive agent and a negative electrode binder.

The negative electrode active material is not particularly limited as long as it may electrochemically intercalate and deintercalate lithium ions, but, may be, for example, a graphite active material (artificial graphite, natural graphite, a mixture of artificial graphite and natural graphite, natural graphite coated with artificial graphite), a Si-based active material, or a Sn-based active material (e.g., a mixture of fine particles of silicon (Si) or tin (Sn) or a mixture of oxides thereof and a graphite active material, particulates of silicon or tin, an alloy including silicon or tin as a base material), metallic lithium, a titanium oxide compound such as Li₄Ti₅O₁₂, lithium nitride, and/or the like. As the negative electrode active material, one of the above examples may be utilized, or two or more types (kinds) may be utilized in combination. in one or more embodiments, oxides of silicon may be represented by SiOₓ (0 < × ≤ 2).

The conductive agent is not particularly limited as long as it is for increasing the conductivity of the negative electrode, and for example, the same conductive agent as described in the positive electrode section may be utilized.

A content (e.g., amount) of the conductive agent in the negative electrode mixture layer is not particularly limited, but may be greater than or equal to about 0.1 wt% and less than or equal to about 5 wt%, or greater than or equal to about 0.5 wt% and less than or equal to about 3 wt% based on the total weight of the negative electrode mixture layer, from the viewpoint of achieving both (e.g., simultaneously) conductivity and battery capacity.

The negative electrode binder may be one capable of binding the negative electrode active material and the conductive agent on the negative current collector, and is not particularly limited. The negative electrode binder may be, for example, polyvinylidene fluoride (PVDF), polytetrafluoroethylene (PTFE), polyacrylic acid (PAA), a styrene-butadiene-based copolymer (SBR), a metal salt of carboxymethyl cellulose (CMC), etc. The binder may be utilized alone or may be utilized in mixture of two or more types (kinds).

### 1-3. Separator

The separator is not particularly limited, and any separator may be utilized as long as it is utilized as a separator for a rechargeable lithium ion battery in the art. The separator may be a porous film, nonwoven fabric, and/or the like that exhibits excellent or suitable high-rate discharge performance alone or in combination. A material (e.g., a resin) constituting the separator may be, for example, a polyolefin-based resin such as polyethylene, polypropylene, etc., a polyester resin such as polyethylene terephthalate, polybutylene terephthalate, etc., polyvinylidene difluoride, a vinylidene difluoride-hexafluoropropylene copolymer, a vinylidene difluoride-perfluorovinyl ether copolymer, a vinylidene difluoride-tetrafluoroethylene copolymer, a vinylidene difluoride-trifluoroethylene copolymer, a vinylidene difluoride-fluoroethylene copolymer, a vinylidene difluoride-hexafluoroacetone copolymer, a vinylidene difluoride-ethylene copolymer, a vinylidene difluoride-propylene copolymer, a vinylidene difluoride-trifluoro propylene copolymer, a vinylidene difluoride-tetrafluoroethylene copolymer, a vinylidene difluoride-ethylene-tetrafluoroethylene copolymer, and/or the like. A porosity of the separator is not particularly limited, and it may arbitrarily apply a porosity of the separator of a rechargeable lithium ion battery.

The separator may further include a surface layer covering the surface of the porous film or non-woven fabric described above. The surface layer may include an adhesive for immobilizing the battery element by adhering to the electrode. Non-limiting examples of the adhesive may include a vinylidene fluoride-hexafluoropropylene copolymer, an acid-modified product of vinylidene fluoride polymers, and/or a styrene-(meth)acrylic acid ester copolymer.

### 1-4. Non-Aqueous Electrolyte

As the non-aqueous electrolyte, a non-aqueous electrolyte that has conventionally been utilized for rechargeable lithium ion batteries may be utilized without particular limitation. The non-aqueous electrolyte may have a composition in which an electrolyte salt is included in a non-aqueous solvent, which is a solvent for the electrolyte. Non-limiting examples of the non-aqueous solvent may include cyclic carbonate esters such as propylene carbonate, ethylene carbonate, butylene carbonate, chloroethylene carbonate, fluoroethylene carbonate, and/or vinylene carbonate, cyclic esters such as y-butyrolactone and/or y-valerolactone, chain carbonates such as dimethyl carbonate, diethyl carbonate, and/or ethylmethyl carbonate, chain esters such as methylformate, methylacetate, methylbutyrate, ethyl propionate, propyl propionate, ethers such as tetrahydrofuran or a derivative thereof, 1,3-dioxane, 1,4-dioxane, 1,2-dimethoxyethane, 1,4-dibutoxyethane, methyldiglyme, ethylene glycol monopropyl ether, and/or propylene glycol monopropyl ether, nitriles such as acetonitrile and/or benzonitrile, dioxolane or a derivative thereof, ethylene sulfide, sulfolane, sultone, or a derivative thereof, which may be utilized alone or in a mixture of two or more. In one or more embodiments, when two or more types (kinds) of non-aqueous solvents are mixed and utilized, a mixing ratio of each non-aqueous solvent may be a mixing ratio that may be utilized in a rechargeable lithium ion battery in the art.

Non-limiting examples of the electrolyte salt may include an inorganic ion salt including at least one of lithium (Li), sodium (Na) or potassium (K) such as LiClO₄, LiBF₄, LiAsF₆, LiPF₆, LiPF₆₋ₓ(CₙF₂ₙ+₁)ₓ [provided that 1<x<6, n=1 or 2], LiSCN, LiBr, Lil, Li₂SO₄, Li₂B₁₀Cl₁₀, NaClO₄, Nal, NaSCN, NaBr, KClO₄, or KSCN, or an organic ion salt such as LiCF₃SO₃, LiN(CF₃SO₂)₂, LiN(C₂F₅SO₂)₂, LiN(CF₃SO₂)(C₄F₉SO₂), LiC(CF₃SO₂)₃, LiC(C₂F₅SO₂)₃, (CH₃)4NBF4, (CH₃)₄NBr, (C₂H₅)₄NClO₄, (C₂H₅)₄NI, (C₃H₇)₄NBr, (n-C₄H₉)₄NClO₄, (n-C₄H₉)₄NI, (C₂H₅)₄N-maleate, (C₂H₅)₄N-benzoate, (C₂H₅)₄N-phthalate, stearyl lithium sulfonate, octyl lithium sulfonate, dodecylbenzene lithium sulfonate, and/or the like, and it may also utilize these ionic compounds alone or in a mixture of two or more types (kinds). In some embodiments, a concentration of the electrolyte salt may be the same as that of a non-aqueous electrolyte utilized in a rechargeable lithium ion battery in the art, and embodiments of the present disclosure are not particularly limited. In one or more embodiments, a non-aqueous electrolyte containing the above-described lithium compound (electrolyte salt) at a concentration of greater than or equal to about 0.8 mol/L and less than or equal to about 1.5 mol/L may be utilized.

In some embodiments, one or more suitable additives may be added to the non-aqueous electrolyte. Non-limiting examples of such additives may include negative electrode-acting additives, positive electrode-acting additives, ester additives, carbonate ester additives, sulfuric acid ester additives, phosphoric acid ester additives, boric acid ester additives, acid anhydride additives, and/or electrolyte additives. In some embodiments, one of these may be added to the non-aqueous electrolyte, in some embodiments, a plurality of types (kinds) of additives may be added.

### 2. Characteristic Configuration of Non-aqueous Electrolyte Rechargeable Battery According to an Embodiment

Hereinafter, the characteristic configuration of the non-aqueous electrolyte rechargeable battery according to one or more embodiments of the present disclosure will be described in more detail.

The positive electrode mixture layer of the non-aqueous electrolyte rechargeable battery according to one or more embodiments of the present disclosure may include, in addition to the aforementioned components, composite particles that function as an endothermic conductive agent for a non-aqueous electrolyte rechargeable battery.

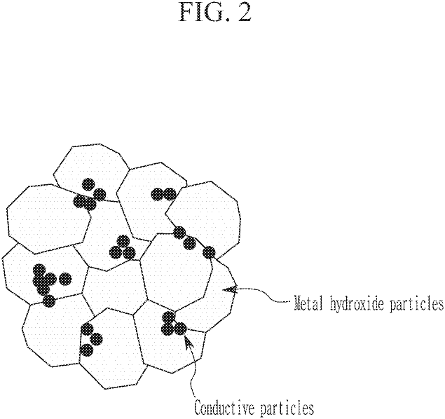

In one or more embodiments, the composite particles are composite particles in which metal hydroxide particles capable of absorbing heat through an endothermic reaction and conductive particles having conductivity are composited. As shown in FIG. 2, the composite particles may be obtained by mixing the metal hydroxide particles and the conductive particles as uniformly as possible. Herein, the composite may refer to a state in which a plurality of particles are formed into a single aggregate by chemically bonding with each other through functional groups (for example, carboxyl group and/or hydroxyl group) possessed by each particle. The chemical bonds herein may include not only covalent bonds as described above, but also one or more suitable bonds such as ionic bonds, coordinate bonds, and metal bonds. In one or more embodiments, the bonding state between the particles may be confirmed by, for example, X-ray photoelectron spectroscopy and/or the like.

The metal hydroxide particles are not particularly limited as long as they may cause an endothermic reaction. Non-limiting examples of the metal hydroxide may include aluminum hydroxide, pseudo-boehmite, boehmite, alumina, and kaolinite. These may be utilized alone or may be utilized in a combination of two or more types (kinds).

In one or more embodiments, an average primary particle diameter of the metal hydroxide particles may be greater than or equal to about 10 nm and less than or equal to about 20 µm, or greater than or equal to about 50 nm and less than or equal to about 10 µm.

The conductive particle may have electroconductivity, and it is not specifically limited. non-limiting examples of the material which includes the conductive particles may include a carbon material, a metal nanoparticle, etc.

Non-limiting examples of the metal nanoparticles may include gold nanoparticles, silver nanoparticles, and/or copper nanoparticles.

Non-limiting examples of the carbon material may include at least one selected from carbon black, natural graphite, artificial graphite, fibrous carbon, and sheet-like carbon.

Non-limiting examples of the carbon black may include furnace black, channel black, thermal black, ketjen black, and/or acetylene black.

Non-limiting examples of the fibrous carbon may include single-walled carbon nanotubes and/or multi-layer carbon nanotubes, and non-limiting examples of sheet-like carbon may include graphene and/or the like.

In one or more embodiments, the composite particle contains the above-mentioned conductive particles, and a ratio (A_{D} / A_{G}) of a peak area (A_{D}) around 1350 cm⁻¹ and a peak area (A_{G}) around 1580 cm⁻¹ measured by Raman spectroscopy of the composite particles may be greater than or equal to about 0.5 and less than or equal to about 3.5, for example, greater than or equal to about 1.1 and less than or equal to about 1.3, and a peak full width at half maximum (G′-FWHM) around 2680 cm⁻¹ measured by Raman spectroscopy may be greater than or equal to about 60 cm⁻¹ and less than or equal to about 150 cm⁻¹, for example, greater than or equal to about 80 cm⁻¹ and less than or equal to about 85 cm⁻¹.

In one or more embodiments, an average primary particle diameter or a fiber length of the conductive particle may be greater than or equal to about 1 nm and less than or equal to about 10 µm, or greater than or equal to about 10 nm and less than or equal to about 1 µm. In the embodiments of utilizing metal nanoparticles as the conductive particles, any particle size (diameter) may be utilized as long as the average primary particle size (diameter) is in nanometers, for example, in one or more embodiments, the average primary particle size (diameter) of metal nanoparticles may be greater than or equal to about 1 nm and less than or equal to about 500 nm.

In one or more embodiments, a content (e.g., amount) of the metal hydroxide particles in the composite particles may be in the range of greater than or equal to about 1 wt% and less than or equal to about 60 wt%, greater than or equal to about 5 wt% and less than or equal to about 50 wt%, or greater than or equal to about 10 wt% and less than or equal to about 40 wt% based on the total weight of the composite particles.

In one or more embodiments, a content (e.g., amount) of the conductive particles in the composite particles may be in the range of greater than or equal to about 0.1 wt% and less than or equal to about 25 wt%, greater than or equal to about 0.5 wt% and less than or equal to about 20 wt%, or greater than or equal to about 1 wt% and less than or equal to about 15 wt% based on the total weight of the composite particles.

The composite particles may have a specific surface area and a degree of modification by one or more suitable modifiers within the following ranges.

In one or more embodiments, a specific surface area (BET1) calculated based on the adsorption isotherm measured by adsorbing water vapor to the composite particles may be greater than or equal to about 8 m²/g and less than or equal to about 600 m²/g, and concurrently (e.g., at the same time) a specific surface area (BET2) calculated based on the adsorption isotherm measured by adsorbing nitrogen to the composite particles may be greater than or equal to about 8 m²/g and less than or equal to about 600 m²/g, for example, may be greater than or equal to about 10 m²/g and less than or equal to about 600 m²/g.

In one or more embodiments, BET1 may be greater than or equal to about 10 m²/g and less than or equal to about 300 m²/g, or greater than or equal to about 12 m²/g and less than or equal to about 100 m²/g.

In one or more embodiments, BET2 may be greater than or equal to about 9 m²/g and less than or equal to about 300 m²/g, or greater than or equal to about 10 m²/g and less than or equal to about 100 m²/g.

In one or more embodiments, a specific surface area ratio (BET1/BET2), which is a ratio between BET1 and BET2, may be greater than or equal to about 0.2 and less than or equal to about 5.0, greater than or equal to about 0.5 and less than or equal to about 4.0, or greater than or equal to about 1.0 and less than or equal to about 3.0.

In one or more embodiments, when the composite particles are heated from about 80° C. to about 1400° C., the amount of P₂ gas desorbed from the composite particles may be measured by TDS-MS and the amount of desorbed P₂ (referred to as MS1) may be greater than or equal to about 300 × 10⁻⁶ mol/g and less than or equal to about 3000 × 10⁻⁶ mol/g, for example, greater than or equal to about 500 × 10⁶ mol/g and less than or equal to about 1000 × 10⁻⁶ mol/g. In the present disclosure, the amount of desorbed P₂ gas (MS1) is an index showing the degree of modification of the composite particles with phosphonic acid.

In one or more embodiments, when the composite particles are heated from about 80° C. to about 1400° C., the amount of H₂O (referred to as MS2) desorbed from the composite particles measured by TDS-MS may be greater than or equal to about 30 × 10⁻⁶ mol/g and less than or equal to about 1500 × 10⁻⁶ mol/g, for example, may be greater than or equal to about 100 × 10⁻⁶ mol/g and less than or equal to about 1500 × 10⁻⁶ mol/g. The amount of desorbed H₂O may be a reference value for the degree of modification of the composite particles, and a ratio of the amount of desorbed (MS1/MS2) may be greater than or equal to about 0.5 and less than or equal to about 5.0, greater than or equal to about 1.0 and less than or equal to about 4.0, or greater than or equal to about 1.5 and less than or equal to about 3.0.

In order to further enhance the endothermic effect of the composite particles, the composite particles may be modified with a functional group such as a CH₃ group or a CH₂OH group. The degree of modification by these functional groups may be evaluated by the desorption amount of the following one or more suitable gases derived from these functional groups in substantially the same way as the degree of modification by phosphonic acid, and the desorption amount of one or more suitable gases satisfies the following ranges.

In one or more embodiments, the amount of CH₄ (referred to as MS3) desorbed from the composite particles when the composite particles are heated from about 80° C. to about 1400° C. measured by TDS-MS may be greater than or equal to about 30 × 10⁻⁶ mol/g and less than or equal to about 1000 × 10⁻⁶ mol/g and the amount of desorbed CH₃OH (referred to as MS4) measured in substantially the same way may be greater than or equal to about 10 × 10⁻⁶ mol/g and less than or equal to about 3000 × 10⁻⁶ mol/g, for example, may be greater than or equal to about 10 × 10⁻⁶ mol/g and less than or equal to about 1000 × 10⁻⁶ mol/g.

In one or more embodiments, MS3 may be greater than or equal to about 50 × 10⁻⁶ mol/g and less than or equal to about 300 × 10⁻⁶ mol/g, or greater than or equal to about 60 × 10⁻⁶ mol/g and less than or equal to about 250 × 10⁻⁶ mol/g.

In one or more embodiments, MS4 may be greater than or equal to about 20 × 10⁻⁶ mol/g and less than or equal to about 2000 × 10⁻⁶ mol/g, or greater than or equal to about 25 × 10⁻⁶ mol/g and less than or equal to about 1900 × 10⁻⁶ mol/g.

In one or more embodiments, when the composite particles are modified with a functional group containing a phenyl group, it is easy to disperse the composite particles in a solvent when preparing a slurry such as a positive electrode mixture slurry.

The amount of desorbed C₆H₆ (referred to as MS5) from about 80° C. to about 1400° C. measured by TDS-MS of the composite particles may be greater than or equal to about 1 × 10⁻⁶ mol/g and less than or equal to about 4000 × 10⁻⁶ mol/g, greater than or equal to about 2 × 10⁻⁶ mol/g and less than or equal to about 2000 × 10⁻⁶ mol/g, or greater than or equal to about 3 × 10⁻⁶ mol/g and less than or equal to about 1600 × 10⁻⁶ mol/g.

In one or more embodiments, a total content (e.g., amount) of the modifying molecules in the composite particles may be in the range of greater than or equal to about 10 wt% and less than or equal to about 90 wt%, greater than or equal to about 20 wt% and less than or equal to about 80 wt%, or greater than or equal to about 30 wt% and less than or equal to about 70 wt% based on 100 wt% of the total composite particles.

As for the endothermic property of the composite particles realized by the surface area and the degree of modification by one or more suitable modifiers as described above, the endothermic amount of the composite particles between about 50° C. to about 250° C. in differential scanning calorimetry may be greater than or equal to about 150 J/g and less than or equal to about 500 J/g, greater than or equal to about 170 J/g and less than or equal to about 400 J/g, or greater than or equal to about 180 J/g and less than or equal to about 300 J/g.

Even when the composite particles are included in the positive electrode mixture layer or the negative electrode mixture layer, in order not to decrease the conductivity as much as possible, the volume resistivity of the composite particles when pressurized at about 60 MPa may be greater than or equal to about 0.1 Ωcm and less than or equal to about 4 × 10⁴ Ωcm. In one or more embodiments, the volume resistivity of the composite particles may be greater than or equal to about 0.3 Ωcm and less than or equal to about 3.8 × 10⁴ Ωcm, or greater than or equal to about 0.5 Ωcm and less than or equal to about 3.6 × 10⁴ Ωcm.

In one or more embodiments, a content (e.g., amount) of the composite particles in the positive electrode mixture layer may be in the range of greater than or equal to about 0.1 wt% and less than or equal to about 5 wt%, greater than or equal to about 0.2 wt% and less than or equal to about 3 wt%, or greater than or equal to about 0.5 wt% and less than or equal to about 2 wt% based on the total weight of the positive electrode mixture layer.

The content (e.g., amount) of the composite particles for the non-aqueous electrolyte rechargeable battery based on the total weight of non-aqueous electrolyte rechargeable battery may be different depending on the utilization of the non-aqueous electrolyte rechargeable battery and thus is not limited to the following range. However, for example, in one or more embodiments, the content (e.g., amount) of composite particles for the non-aqueous electrolyte rechargeable battery included in the non-aqueous electrolyte rechargeable battery may be in the range of greater than or equal to about 0.01 wt% and less than or equal to about 5.0 wt%, greater than or equal to about 0.02 wt% and less than or equal to about 2.0 wt%, or greater than or equal to about 0.1 wt% and less than or equal to about 0.5 wt% based on the total weight, 100 wt%, of the non-aqueous electrolyte rechargeable battery.

### 3. Manufacturing Method of Non-Aqueous Electrolyte Rechargeable Battery According to an Embodiment

Hereinafter, a manufacturing method of a rechargeable lithium ion battery according to one or more embodiments of the present disclosure is described in more detail.

### 3-1. Preparing Method of Composite Particles

The composite particle for the non-aqueous electrolyte rechargeable battery according to one or more embodiments of the present disclosure may be produced by preparing first composite particles of metal hydroxide particles and conductive particles and modifying the first composite particle.

The first composite particles are obtained by first mixing and drying a metal oxynitride, which is a raw material of the metal hydroxide, and conductive particles while heating to prepare metal hydroxide particles, and at the same time, by forming first composite particles of metal hydroxide particles and conductive particles.

The heating temperature may be greater than or equal to about 80° C. and less than or equal to about 200° C., or greater than or equal to about 120° C. and less than or equal to about 180° C.

A method of heat-mixing the raw material of the metal hydroxide and conductive particles may be a method of utilizing a spray dryer. Because the first composite particles are obtained in a state in which metal hydroxide particles and conductive particles are composited as uniformly as possible by utilizing this spray dryer, a spray dryer may be desirably utilized for production of the first composite particles.

A method of modifying the first composite particles may be, for example, a method of immersing the first composite particles in a modifying agent for a set or predetermined period of time, and/or the like.

Non-limiting examples of the modifying agent may include phosphoric acid, phosphonic acid (such as phosphonic acid, ethylphosphonic acid, and phenylphosphonic acid), and/or phosphinic acid (such as phosphinic acid and diphenylphosphinic acid).

The treatment time for modifying the first composite particles may be appropriately changed depending on the type or kind or concentration of the treatment agent (e.g., modifying agent), but may be greater than or equal to about 30 minutes and less than or equal to about 48 hours, or greater than or equal to about 1 hour and less than or equal to about 30 hours.

The treatment temperature may also be appropriately selected according to the type or kind and concentration of the treatment agent, but may be greater than or equal to about 30° C. and less than or equal to about 90° C., or greater than or equal to about 40° C. and less than or equal to about 80° C.

### 3-2. Manufacturing Method of Positive Electrode

In one or more embodiments, the positive electrode may be produced as follows. First, a positive electrode slurry may be formed by dispersing a mixture of a positive electrode active material, a conductive agent, a positive electrode binder, and composite particles in a desired or suitable ratio in a solvent for a positive electrode slurry. Next, this positive electrode slurry may be coated on a positive electrode current collector and dried to form a positive electrode mixture layer. The coating method of the present disclosure is not particularly limited thereto. In one or more embodiments, the coating method may include a knife coater method, a gravure coater method, a reverse roll coater method, a slit die coater method, and/or the like. Each of the following coating processes is also performed by the same method. Subsequently, the positive electrode material mixture layer is pressed by a press to have a desired or suitable density. Thus, a positive electrode is manufactured.

### 3-3. Manufacturing Method of Negative Electrode

In one or more embodiments, the negative electrode may also be produced in substantially the same way as the positive electrode. First, a negative electrode slurry may be prepared by dispersing a mixture of materials constituting the negative electrode mixture layer in a solvent for a negative electrode slurry. Next, a negative electrode mixture layer may be formed by coating the negative electrode slurry on the negative current collector and drying it. Next, the negative electrode material mixture layer may be pressed by a press machine so as to have a desired or suitable density. Thus, a negative electrode is manufactured.

### 3-4. Manufacturing Method of Non-aqueous Electrolyte Rechargeable Battery

Next, an electrode structure may be manufactured by placing a separator between the positive electrode and the negative electrode. Then, the electrode structure may be processed into a desired or suitable shape (e.g., cylindrical shape, prismatic shape, laminated shape, button shape, etc.) and inserted into a container of the above shape. Subsequently, a non-aqueous electrolyte is inserted into the corresponding container to impregnate the electrolyte into each pore in the separator and/or a gap between the positive and negative electrodes. Accordingly, a rechargeable lithium ion battery is manufactured.

### 4. Effect by the Present Embodiment

According to the non-aqueous electrolyte rechargeable battery configured as described above, even in an environment where the internal temperature is likely to rise due to battery abnormalities such as internal short circuits, the increase in the internal temperature of the non-aqueous electrolyte rechargeable battery may be sufficiently suppressed or reduced, and electrical resistance of the non-aqueous electrolyte rechargeable battery may be suppressed or reduced to a small level.

### 5. Another Embodiment

This present disclosure is not limited to the aforementioned embodiments.

In the aforementioned embodiments, the embodiments in which the positive electrode includes the composite particles according to the present have been described, but the negative electrode may include the composite particles. In embodiments in which the negative electrode includes the composite particles, substantially the same content (e.g., amount) as in the embodiments in which the positive electrode includes the composite particles may be included.

Further, the composite particles may be included in the electrolyte, or may be included in a plurality of locations in the positive electrode, the negative electrode, and the electrolyte.

In one or more embodiments, when the negative electrode includes the composite particles for the non-aqueous electrolyte rechargeable battery, the content (e.g., amount) of the composite particles for the non-aqueous electrolyte rechargeable battery with respect to the entire negative electrode may be in substantially the same range as that of the positive electrode. In one or more embodiments, when the electrolyte includes the composite particles for a non-aqueous electrolyte rechargeable battery, the content (e.g., amount) of the composite particles for the non-aqueous electrolyte rechargeable battery is in the range of greater than or equal to about 0.1 wt% and less than or equal to about 10.0 wt% when the total weight of the electrolyte is 100 wt%.

In addition, the present disclosure is not limited to these embodiments but may be variously modified without deviating from the purpose.

### EXAMPLES

Hereinafter, the present disclosure will be described in more detail according to specific examples. However, the following examples are merely examples of the present disclosure, and the present disclosure is not limited to the following examples.

### Production of Endothermic Particles

### Example 1 to 4 and Comparative Example 4

50.0 g of aluminum nitrate nonahydrate and 5.0 g of acetylene black were dispersed in 250 cc (cubic centimeter) of ethanol. This dispersion was spray-dried at 150° C. with a spray dryer manufactured by GF Corp., obtaining Composite Particles A′ before modification (BET1 : 344 m²/g, BET2 : 1.2 m²/g), in which aluminum hydroxide particles and acetylene black particles were bonded.

### Examples 5 and 7

50.0 g of aluminum nitrate nonahydrate and 25.0 g of acetylene black were dispersed in 250 cc of ethanol. This dispersion was spray dried at 150° C. with a spray dryer manufactured by GF Corp., obtaining Composite Particles B′ before modification (BET1 : 344 m²/g, BET2 : 1.2 m²/g), in which aluminum hydroxide particles and acetylene black particles were bonded.

### Example 6

50.0 g of aluminum nitrate heptahydrate and 1.0 g of acetylene black were dispersed in 250 cc of ethanol. This dispersion was spray dried at 150° C. with a spray dryer manufactured by GF Corp., obtaining Composite Particles C′ before modification (BET1 : 344 m²/g, BET2 : 1.2 m²/g), in which aluminum hydroxide particles and acetylene black particles were bonded.

### Modification Treatment of Endothermic Particles

### Example 1

1.0 g of Composite Particles A′ before modification and 3.0 g of phosphoric acid were dispersed in 50 cc of a mixed solution of ethanol and purified water (a volume mixing ratio of 1 : 1). This dispersion was heated at 80° C. for 4 hours and vacuum-dried, obtaining modified Composite Particles A.

### Example 2

Modified Composite Particles B were obtained in substantially the same manner as in Example 1 except that 1.0 g of Composite Particles A′ before modification and 3.0 g of ethylphosphonic acid were dispersed in 50 cc of a mixed solution of ethanol and purified water (a volume mixing ratio of 1 : 1).

### Example 3

Modified Composite Particles C were obtained in substantially the same manner as in Example 1 except that 1.0 g of Composite Particles A′ before modification and 3.0 g of phenylphosphonic acid were dispersed in 50 cc of a mixed solution of ethanol and purified water (a volume mixing ratio of 1 : 1).

### Example 4

Modified Composite Particles D were obtained in substantially the same manner as in Example 1 except that 1.0 g of Composite Particles A′ before modification and 3.0 g of diphenylphosphinic acid were dispersed in 50 cc of a mixed solution of ethanol and purified water (a volume mixing ratio of 1 : 1).

### Example 5

Modified Composite Particles E were obtained in substantially the same manner as in Example 1 except that 1.0 g of Composite Particles B′ before modification and 3.0 g of phenylphosphonic acid were dispersed in 50 cc of a mixed solution of ethanol and purified water (a volume mixing ratio of 1 : 1).

### Example 6

Modified Composite Particles F were obtained in substantially the same manner as in Example 1 except that 1.0 g of Composite Particles C′ before modification and 5.0 g of phenylphosphonic acid were dispersed in 50 cc of a mixed solution of ethanol and purified water (a volume mixing ratio of 1 : 1).

### Comparative Example 6

Modified Pseudo-boehmite Particles were obtained in substantially the same manner as in Example 1 except that 1.0 g of pseudo-boehmite (BET1 : 407 m²/g, BET2 : 377 m²/g) and 3.0 g of phenylphosphonic acid were dispersed in 50 cc of a mixed solution of ethanol and purified water (a volume mixing ratio of 1 : 1).

### Preparation of Mixture of Endothermic Particles and Conductive Particles Comparative Example 7

10.0 g of modified pseudo-boehmite particles of Comparative Example 6 and 10.0 g of acetylene black were mixed for 10 minutes with a V-type or kind mixer manufactured by Dalton Corp., obtaining Particle Mixture a.

### Comparative Example 8

20.0 g of modified pseudo-boehmite particles of Comparative Example 6 and 10.0 g of acetylene black were mixed for 10 minutes with a V-type or kind mixer manufactured by Dalton Corp., obtaining Particle Mixture b.

### Comparative Example 9

10.0 g of modified pseudo-boehmite particles of Comparative Example 6 and 30.0 g of acetylene black were mixed for 10 minutes with a V-type or kind mixer manufactured by Dalton Corp., obtaining Particle Mixture c.

### Comparative Example 10

10.0 g of pseudo-boehmite particles (BET1 : 407 m²/g, BET2 : 377 m²/g) and 10.0 g of acetylene black were mixed with a V-type or kind mixer manufactured by Dalton Corp. for 10 minutes, obtaining Particle Mixture d.

### Manufacture of Positive Electrode

### Examples 1 to 6 and Comparative Examples 2 to 10

LiCoO₂, acetylene black, polyvinylidene fluoride, and endothermic particles were mixed and dispersed in an N-methyl-2-pyrrolidone solvent at a weight ratio of 97.0:1.0:1.3:0.7 as dry powders, respectively, to prepare a positive electrode mixture slurry. Subsequently, the slurry was coated on one surface of an aluminum current collector foil to have a coating amount of the mixture (surface density) of 20.0 mg/cm² per one surface after drying, and then dried, and then pressed with a roll press machine to have a mixture layer density of 4.15 g/cc, manufacturing each positive electrode.

### Comparative Example 1 and Example 7

Each positive electrode was manufactured in substantially the same manner as in Example 1 except that the positive electrode mixture slurry was prepared by mixing and dispersing LiCoO₂, acetylene black, and polyvinylidene fluoride in an N-methyl-2-pyrrolidone solvent at a weight ratio of 97.7 : 1.0 : 1.3 as dry powders, respectively.

### Manufacture of Negative Electrode

### Examples 1 to 6 and Comparative Examples 1 to 10

Artificial graphite, a carboxylmethyl cellulose (CMC) sodium salt, and a styrene butadiene-based aqueous dispersed body as dry powders in a weight ratio of 97.5: 1.0 : 1.5 were dissolved and dispersed in a water solvent, preparing a negative electrode mixture slurry. Subsequently, the negative electrode mixture slurry was coated and dried on one surface of a copper foil to have a coating amount of the mixture (surface density) of 10.5 mg/cm² per one surface, then dried, and then, pressed with a roll press to have the mixture layer density of 1.65 g/cc, manufacturing a negative electrode.

### Example 7

A negative electrode was manufactured in substantially the same manner as in Example 1 except that the negative electrode mixture slurry was prepared by dissolving and dispersing artificial graphite, a carboxylmethyl cellulose (CMC) sodium salt, a styrene butadiene-based aqueous dispersed body, and the composite particles E of Example 5 as dry powders in a weight ratio of 96.5 : 1.0 : 1.5 : 1.0 in a water solvent.

### Manufacture of Rechargeable Battery Cells

### Examples 1 to 7 and Comparative Examples 1 to 10

A plurality of the positive electrodes and a plurality of the negative electrode were stacked with polypropylene porous separator(s) between the positive and negative electrodes to have battery design capacity of 300 mAh, manufacturing an electrode stack. Subsequently, a rechargeable battery cell before the initial charge was manufactured by welding nickel and aluminum lead wires respectively to the negative and positive electrodes of the electrode stack, housing the electrode stack in an aluminum laminate film with the lead wires externally pulled out, injecting an electrolyte thereinto, and sealing the aluminum laminate film under a reduced pressure. The electrolyte was prepared by dissolving 1.3 M LiPF₆ and 1 wt% of vinylenecarbonate in a mixed solvent of ethylenecarbonate / dimethylcarbonate / fluoroethylenecarbonate in a volume ratio of 15 / 80 / 5.

### Evaluation of Endothermic Particles

The endothermic particles utilized in examples and comparative examples were evaluated as follows.

### Specific Surface Area (BET) of Endothermic Particles

The specific surface area (BET (BET 1 or BET2) calculated based on the adsorption isotherm measured by adsorbing water vapor or nitrogen) of the inorganic particles or composite particles was measured utilizing a gas adsorption amount measuring device (BELSORP manufactured by Microtrac Bell), according to JIS K6217-2.

### Mass of Desorbed Gas

Thermal desorption gas mass spectrometry (TDS-MS) was conducted by utilizing a thermal desorption gas mass spectrometer (TDS-1200, ESCO, Ltd.) to measure and analyze each desorbed amount of methane molecules, methanol molecules, benzene molecules, diphosphorus molecules, and water molecules, as follows.

In TDS, the inorganic particles or composite particles were set by utilizing a sample stage made of quartz and a sample dish made of SiC. In addition, the temperature increase rate was 60° C./min. The temperature increase was controlled or selected by monitoring a temperature on the sample surface. Furthermore, a weight of the sample was 1 mg, which was corrected by an actual weight. A quadruple mass spectrometer was utilized for a detection, and a voltage applied thereto was 1000 V.

TDS was utilized to measure an amount (µmol/g, i.e., 10⁻⁶ mol/g) of each gas desorbed from the inorganic particles or composite particles during the temperature increase from 80° C. to 1400° C. The mass number [M/z] utilized for analyzing the measurements was 15 for CH₄, 18 for H₂O, 31 for CH₃OH, 62 for P₂, and 78 for C₆H₆, wherein gases corresponding to the mass numbers were all each of the aforementioned substances. Herein, regarding the gas amount of H₂O, an integrated value only from 80° C. to 200° C. out of the entire temperature range was utilized to obtain the desorbed H₂O amount (MS2).

### Maximum Endothermic Peak Temperature

The maximum endothermic peak temperature of the endothermic particles was measured by increasing a temperature at a heating rate of 5 K/min utilizing a differential scanning calorimetry device (manufactured by Hitachi High-Tech Science Co., Ltd.) according to JIS K7121, and confirming a peak of the endothermic decomposition temperature.

### Confirmation of Heat Generation at 150° C. or Less Under Coexistence of Endothermic Particles and Electrolyte

After putting 2.0 mg of the endothermic particles and 0.5 mg of the same electrolyte as utilized to manufacture the rechargeable battery cells into a dedicated airtight container and caulking it, whether or not an exothermic peak was found at 150° C. or less was examined by checking an endothermic peak in substantially the same method as described. As a result, in Comparative Examples 6 to 9, a clear exothermic peak was observed around 100° C., but in Examples 1 to 7, this exothermic peak was not observed.

### Volume Density and Volume Resistance of Powder When Pressurized at 60 MPa

Using MCP-PD51, Nitto Seiko Analytech Co., Ltd., the volume density and the volume resistivity of the pressurized powder were measured when the endothermic particles filled in the cylindrical cylinder were made into powder pressed by a hydraulic press. Measurement conditions are as follows.

Load: 18.85 kN

Electrode gap: 3.0 mm

Electrode radius: 0.7 mm

Sample radius: 10.0 mm

Probe utilized: 4 probes

### Raman Spectroscopic Analysis

Each endothermic particle was measured at an excitation wavelength of 532.36 nm utilizing NRS-5100, Nippon Spectroscopy Co., Ltd. as a microscopic laser Raman spectrometer. Measurement conditions are as follows.

Exposure time: 10 seconds

Cumulative times: 20 times

Diffraction lattice: 300/mm (600 nm)

Of the Raman spectra of the entire measured area, curve fitting was performed on the spectrum from 800 cm⁻¹ to 3500 cm⁻¹ to obtain a ratio (A_{D} / A_{G}) of the peak area (A_{D}) around 1350 cm⁻¹ to the peak area (A_{G}) around 1580 cm⁻¹, and a peak full width at half maximum (G′-FWHM) around 2680 cm⁻¹.

### Evaluation of Rechargeable Battery Cells

### Cell Resistance

The fully charged initial cell resistance was measured by electrochemical impedance spectroscopy (EIS, VMP-3 Potentiostat) at 25° C. As a measurement condition, the frequency range was 100 kHz to 100 mHz, and the applied voltage was 10 mV. The diameter of the semicircular arc of the Nyquist plot obtained from the measurement results was used as the cell resistance.

### Cycle Characteristics

The rechargeable battery cells according to Examples 1 to 7 and Comparative Examples 1 to 10 were charged under a constant current to 4.3 V at 0.1 CA of design capacity and charged under a constant voltage to 0.05 CA still at 4.3 V in a 25° C. thermostat. Subsequently, the cells were discharged under a constant current to 3.0 V at 0.1 CA. In addition, the cells were measured with respect to initial discharge capacity after the 1^{st} cycle through a constant current charge at 0.2 CA, a constant voltage charge at 0.05 CA, and a constant current discharge at 0.2 CA under conditions of a charge cut-off voltage of 4.3 V and a discharge cut-off voltage of 3.0 V in the 25° C. thermostat. The rechargeable battery cells were (each) 100 cycles charged and discharged through a constant current charge at 0.5 CA, a constant voltage charge at 0.05 CA, and a constant current discharge 0.5 CA under conditions of a charge cut-off voltage of 4.3 V and a discharge cut-off voltage of 3.0 V at 45° C. to test a cycle-life. After the 100 cycles, discharge capacity at a constant current charge of 0.2 CA, a constant voltage charge of 0.05 CA, and a discharge at 0.2 CA of (each of) the cells was measured and was divided by the initial discharge capacity to obtain capacity retention after the 100 cycles.

### Heating Test

The rechargeable battery cells according to Examples 1 to 7 and Comparative Examples 1 to 10 were charged under a constant current to 4.42 V at design capacity of 0.1 CA and charged under a constant voltage at 4.42 V to 0.05 CA in the 25° C. thermostat. Subsequently, the cells were discharged to 3.0 V at 0.1 CA under a constant current. In addition, in the 25° C. thermostat, after performing a constant current charge at 0.2 CA, a constant voltage charge at 0.05 CA, and a constant current discharge at 0.2 CA under conditions of a charge cut-off voltage of 4.42 V and a discharge cut-off voltage of 3.0 V as 1 cycle, the cells were charged again under a constant current/constant voltage- to 4.42 V, which were regarded as initial cells. These rechargeable battery cells were left for 1 hour in a thermostat heated to 165° C., and a case where a voltage of a battery cell became 4.3 V or less was regarded as “abnormal occurrence”, and an abnormal occurrence rate was evaluated in the 10 battery tests.

### Nail Penetration Test

A nail penetration test was conducted by penetrating the aforementioned initial cells in the center with a nail (stainless steel or soft iron) having a diameter of 3 mm at 50 mm/s. A case where an external temperature of a battery cell reached 50° C. or higher 5 seconds after penetrated with the nail was regarded as “abnormal occurrence,” and an abnormal occurrence rate was evaluated in the 10 battery tests.

### Overcharge Test

A case where an external temperature of a battery cell reached 50° C. or higher after additionally charging the aforementioned initial cells under a constant current to 12 V at 3 CA and then, charging them under a constant voltage for 10 minutes after reaching 12 V was regarded as “abnormal occurrence,” an abnormal occurrence rate was evaluated in the 10 battery tests.

### Evaluation Results

Table 1 shows types (kinds), physical properties, and locations of the inorganic particles or endothermic particles utilized in the examples and the comparative examples described above. In addition, the evaluation results of the rechargeable battery cells according to Examples 1 to 7 and Comparative Examples 1 to 10 are shown in Table 2.

TABLE 1

| | Endotherm ic particle | Vol um e resi stiv ity ( Ω c m ) | 50 to 250° C. en do th er mi c a m ou nt ( J/ 9 ) | Thermal desorption gas mass | | | | | | Specific surface area | | | Raman spectro scopy | | Location including endother mic particles |
|---|---|---|---|---|---|---|---|---|---|---|---|---|---|---|---|
| | | | | M S1 (µ m ol / g ) | MS 2 (µ mo \|/ g ) | De sor pti on ga s am ou nt rati o (-) | MS 3 (µ mo \|/ g ) | MS 4 (µ mo \|/ g ) | MS 5 (µ mo \|/ g ) | BET 1 (m²/ 9) | B E T2 (m ²/g ) | S P e ci fi c s u rf a c e a r e a r a ti o | A_{D} /A G | G′ F W H M (c m⁻ 1 ) | |
| Ex. 1 | composite particle A | 152 | 250 | 754.2 | 281.1 | 2.7 | 62.1 | 26.1 | 3.5 | 59.8 | 51.2 | 1.2 | 1.2 | 82 | positive electrod e |
| Ex. 2 | composite particle B | 117 | 252 | 695.0 | 275.2 | 2.5 | 235.0 | 1824.0 | 3.7 | 68.5 | 53.5 | 1.3 | 1.2 | 83 | positive electrod e |
| Ex. 3 | composite particle C | 103 | 255 | 709.4 | 270.8 | 2.6 | 120.2 | 1143.8 | 752.5 | 72.8 | 32.5 | 2.2 | 1.2 | 82 | positive electrod e |
| Ex. 4 | composite particle D | 112 | 234 | 685.2 | 286.4 | 2.4 | 115.2 | 1121.4 | 1580.2 | 58.2 | 39.5 | 1.5 | 1.2 | 82 | positive electrod e |
| Ex. 5 | composite particle E | 0.5 | 185 | 512.6 | 230.6 | 2.2 | 81.7 | 834.3 | 510.3 | 65.3 | 51 | 1.3 | 1.2 | 82 | positive electrod e |
| Ex. 6 | composite particle F | 35025 | 260 | 964.2 | 635.3 | 1.5 | 182.6 | 1453.8 | 1286.7 | 68.2 | 38.4 | 1.8 | 1.2 | 82 | positive electrod e |
| Ex. 7 | composite particle E | 0.5 | 185 | 512.6 | 230.6 | 2.2 | 81.7 | 834.3 | 510.3 | 65.3 | 51 | 1.3 | 1.2 | 82 | negative electrod e |
| Comp. Ex. 1 | endothermic particles were not added | | | | | | | | | | | | | | |
| Comp. Ex. 2 | acetylene black | 0.02 | 0 | 0.0 | 5.1 | 0.0 | 3.0 | 0.7 | 0.1 | 0.0 | 64.4 | 0.0 | 1.1 | 75 | positive electrod e |
| Comp. Ex. 3 | aluminum hydroxide particle | 1×10¹ 4 | 0 | 0.0 | 8.2 | 0.0 | 1.5 | 0.1 | 0.0 | 3.3 | 3.2 | 1.0 | 0.0 | 0 | positive electrod e |
| Comp. Ex. 4 | composite particle A′ before modificatio n | 0.5 | 650 | 1.2 | 1531.9 | 0.0 | 60.9 | 24.5 | 3.1 | 344.0 | 1.2 | 286.7 | 1.2 | 80 | positive electrod e |
| Comp. Ex. 5 | pseudo-boehmite particle | 1×10¹ 4 | 800 | 0.0 | 1885.4 | 0.0 | 9.4 | 2.5 | 0.2 | 407.0 | 377.0 | 1.1 | 0.0 | 0 | positive electrod e |
| Comp. Ex. 6 | modify pseudo-boehmite particle | 3 ×10¹ 4 | 250 | 986.6 | 733.8 | 1.3 | 208.8 | 1600.9 | 1473.4 | 66.1 | 50.7 | 1.3 | 0.0 | 0 | positive electrod e |
| Comp. Ex. 7 | particle mixture a | 5×10⁷ | 125 | 493.3 | 369.4 | 1.3 | 105.9 | 800.8 | 736.8 | 33.1 | 57.6 | 0.6 | 1.1 | 83 | positive electrod e |
| Comp. Ex. 8 | particle mixture b | 2×10¹ 0 | 167 | 657.7 | 489.2 | 1.3 | 139.2 | 1067.3 | 982.3 | 44.1 | 55.3 | 0.8 | 1.1 | 85 | positive electrod e |
| Comp. Ex. 9 | particle mixture c | 6×10³ | 65 | 246.6 | 183.4 | 1.3 | 52.2 | 400.2 | 368.4 | 16.5 | 142.6 | 0.1 | 1.1 | 85 | positive electrod e |
| Comp. Ex. 10 | particle mixture d | 5×10⁶ | 400 | 0.0 | 942.7 | 0.0 | 4.7 | 1.3 | 0.1 | 203.5 | 190.1 | 1.1 | 1.1 | 80 | positive electrod e |

TABLE 2

| | Heat Generation at 150° C. or less under coexistence of endothermic particles and electrolyte | Cell resist ance (Ω) | Discharge capacity retention after 100 cycles (%) | Abnormal occurrenc e rate in heating test (%) | Abnormal occurrenc e rate in nail penetratio n test (%) | Abnormal occurrenc e rate in overchar ge test (%) |
|---|---|---|---|---|---|---|
| Ex. 1 | None | 1.5 | 90.2 | 0 | 10 | 10 |
| Ex. 2 | None | 1.5 | 90.1 | 0 | 20 | 0 |
| Ex. 3 | None | 1.4 | 90.3 | 0 | 20 | 0 |
| Ex. 4 | None | 1.5 | 90.1 | 0 | 20 | 0 |
| Ex. 5 | None | 1.3 | 90.2 | 0 | 20 | 0 |
| Ex. 6 | None | 1.5 | 90.1 | 0 | 20 | 0 |
| Ex. 7 | None | 1.4 | 90.1 | 0 | 20 | 0 |
| Comp. Ex. 1 | — | 1.5 | 90.2 | 100 | 100 | 100 |
| Comp. Ex. 2 | Yes | 1.4 | 90.4 | 100 | 100 | 100 |
| Comp. Ex. 3 | Yes | 1.9 | 86.5 | 80 | 80 | 80 |
| Comp. Ex. 4 | Yes | 1.5 | 90.2 | 90 | 100 | 100 |
| Comp. Ex. 5 | Yes | 1.9 | 86.3 | 80 | 80 | 80 |
| Comp. Ex. 6 | None | 1.9 | 90.0 | 0 | 20 | 0 |
| Comp. Ex. 7 | None | 1.7 | 90.1 | 50 | 60 | 50 |
| Comp. Ex. 8 | None | 1.8 | 90.0 | 40 | 50 | 40 |
| Comp. Ex. 9 | None | 1.5 | 90.2 | 80 | 80 | 80 |
| Comp. Ex. 10 | Yes | 1.7 | 88.7 | 90 | 90 | 100 |

### Consideration of Examples and Comparative Examples

Referring to the results of Table 2, in Examples 1 to 7, compared with Comparative Examples 1 to 10, even under conditions of easily increasing an internal battery temperature such as an external impact by nailing, overcharging, and/or the like, an abnormal occurrence rate due to an internal battery temperature increase was suppressed or reduced sufficiently to a small/low level. Referring to these results, the composite particles, which are the endothermic particles according to the present disclosure, turned out to suppress or reduce an internal temperature of the non-aqueous electrolyte rechargeable battery cells including the same sufficiently to a low level.

In addition, Examples 1 to 7 included the composite particles according to the present disclosure in a positive or negative electrode all exhibited cell resistance of 1.5 Ω or less, which is equivalent to or less than that of Comparative Example 1 including no composite particles.

Furthermore, referring to the results of each example, even when a type or kind or an amount of a raw material utilized for modification, was changed, or when a location where the composite particles were contained was changed, the same effect was exerted.

On the other hand, in Comparative Example 2 containing the acetylene black particles alone, the cell resistance was reduced, but there was no effect of lowering the abnormal occurrence rate.

In Comparative Example 3 or 5 utilizing nonmodified metal hydroxide, the abnormal occurrence rate was not sufficiently suppressed or reduced, and in addition, the cell resistance also was increased.

In Comparative Example 4 utilizing non-modified composite particles, the cell resistance was suppressed or reduced to a low level, but the abnormal occurrence rate was increased, which shows that a modification degree of the composite particles through a modification treatment was important.

Furthermore, in Comparative Example 6 utilizing pseudo-boehmite having a modification degree within an optimal or suitable range through a modification treatment, the abnormal occurrence rate was suppressed or reduced to a low level, but the cell resistance was increased.

In Comparative Examples 7 to 10 utilizing a particle mixture of modified metal hydroxide particles and conductive particles, effects of reducing both (e.g., simultaneously) of the cell resistance and the abnormal occurrence rate were inferior to those of, Examples 1 to 7. Therefore, the metal hydroxide particles and the conductive particles were not only simply mixed but also utilized as composite particles in which the particles themselves are bonded to each other, which brings about an effect of the present disclosure of sufficiently suppressing and reducing an increase in the cell resistance and concurrently (e.g., simultaneously), an increase in the internal battery temperature.

Herein, it should be understood that terms such as “comprise(s),” “include(s),” or “have/has” are intended to designate the presence of an embodied feature, number, step, element, or a combination thereof, but it does not preclude the possibility of the presence or addition of one or more other features, numbers, steps, elements, or a combination thereof.

The terminology utilized herein is utilized to describe embodiments only and is not intended to limit the present disclosure. In the present disclosure, although the terms “first,” “second,” etc., may be utilized herein to describe one or more elements, components, regions, and/or layers, these elements, components, regions, and/or layers should not be limited by these terms. These terms are only utilized to distinguish one component from another component.

In present disclosure, the average particle diameter (or size) may be measured by a method well suitable to those skilled in the art, for example, may be measured by a particle size analyzer, for example, HORIBA, LA-950 laser particle size analyzer, or may be measured by a transmission electron microscope (TEM) or a scanning electron microscope (SEM). In some embodiments, it is possible to obtain an average particle diameter value by measuring it utilizing a dynamic light scattering method, performing data analysis, counting the number of particles for each particle size range, and calculating from the data. In some embodiments, the average particle diameter (or size) may be measured by a microscope or a particle size analyzer and may refer to a diameter (D50) of particles having a cumulative volume of 50 volume% in a particle size distribution. D50 refers to the average diameter (or size) of particles whose cumulative volume corresponds to 50 vol% in the particle size distribution (e.g., cumulative distribution), and refers to the value of the particle size corresponding to 50% from the smallest particle when the total number of particles is 100% in the distribution curve accumulated in the order of the smallest particle size to the largest particle size. Also, in the present disclosure, when particles are spherical, “diameter” indicates a particle diameter or an average particle diameter, and when the particles are non-spherical, the “diameter” indicates a major axis length or an average major axis length.

Herein, “or” is not to be construed as an exclusive meaning, for example, “A or B” is construed to include A, B, A+B, and/or the like. Further, as used herein, the term “and/or” includes any and all combinations of one or more of the associated listed items. Expressions such as “at least one of,” “one of,” and “selected from,” when preceding a list of elements, modify the entire list of elements and do not modify the individual elements of the list. For example, “at least one of a, b, or c”, and “at least one of a, b, and/or c” may indicate only a, only b, only c, both (e.g., simultaneously) a and b, both (e.g., simultaneously) a and c, both (e.g., simultaneously) b and c, all of a, b, and c, or variations thereof.

As utilized herein, the singular forms “a,” “an,” and “the” are intended to include the plural forms as well, unless the context clearly indicates otherwise. Further, the use of “may” when describing embodiments of the present disclosure may refer to “one or more embodiments of the present disclosure”.

As utilized herein, the terms “substantially,” “about,” and similar terms are used as terms of approximation and not as terms of degree, and are intended to account for the inherent deviations in measured or calculated values that would be recognized by those of ordinary skill in the art.

Any numerical range recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein.

While the present disclosure has been described in connection with what is presently considered to be practical example embodiments, it is to be understood that the present disclosure is not limited to the disclosed embodiments. In contrast, it is intended to cover one or more suitable modifications and equivalent arrangements included within the spirit and scope of the appended claims and equivalents thereof.

What is claimed is:

1. A composite particle for a non-aqueous electrolyte rechargeable battery, the composite particle comprising metal hydroxide particles and conductive particles,
wherein a volume resistivity of the composite particle at the time of about 60 MPa pressurization is greater than or equal to about 0.10 Ωcm and less than or equal to about 4 × 10⁴ Ωcm,
an endothermic amount of the composite particle between about 50° C. to about 250° C. in differential scanning calorimetry is greater than or equal to about 150 J/g and less than or equal to about 500 J/g, and
an amount of desorbed P₂ (MS1) of the composite particle from about 80° C. to about 1400° C. by thermal desorption gas mass spectrometry (TDS-MS) is greater than or equal to about 300 × 10-⁶ mol/g and less than or equal to about 3000 × 10⁶ mol/g.

2. The composite particle of claim 1, wherein
an amount of desorbed H₂O (MS2) of the composite particle from about 80° C. to about 200° C. as determined by a thermal desorption gas mass spectrometry (TDS-MS) is greater than or equal to about 30 × 10⁶ mol/g and less than or equal to about 1500 × 10⁶ mol/g, and a desorption gas amount ratio (MS1/MS2) satisfies Formula (1):
$$0.5 \leq \left(\text{MS1} / \text{MS2}\right) \leq 5.0 \qquad \text{(1)}$$
.

3. The composite particle of claim 1, wherein
a ratio (A_{D} / A_{G}) of a peak area (A_{D}) around 1350 cm⁻¹ and a peak area (A_{G}) around 1580 cm⁻¹ measured by Raman spectroscopy of the composite particle is greater than or equal to about 0.5 and less than or equal to about 3.5, and
a peak full width at half maximum (G′-FWHM) around 2680 cm-¹ measured by Raman spectroscopy of the composite particle is greater than or equal to about 60 cm⁻¹ and less than or equal to about 150 cm¹.

4. The composite particle of claim 1, wherein
a specific surface area (BET1) of the composite particle calculated based on an adsorption isotherm measured by adsorbing water vapor is greater than or equal to about 8 m²/g and less than or equal to about 600 m²/g, and
a specific surface area (BET2) of the composite particle calculated based on an adsorption isotherm measured by adsorbing nitrogen is greater than or equal to about 8 m²/g and less than or equal to about 600 m²/g.

5. The composite particle of claim 4, wherein a specific surface area ratio (BET1/BET2) satisfies Formula (2):
$$0.2 \leq \left(\text{BET1} / \text{BET2}\right) \leq 5.0 \qquad \text{(2)}$$
.

6. The composite particle of claim 1, wherein
an amount of desorbed CH₄ (MS3) of the composite particle from about 80° C. to about 1400° C. by thermal desorption gas mass spectrometry (TDS-MS) is greater than or equal to about 30 × 10⁻⁶ mol/g and less than or equal to about 1000 × 10-⁶ mol/g, and
an amount of desorbed CH₃OH (MS4) of the composite particle from about 80° C. to about 1400° C. by TDS-MS is greater than or equal to about 10 × 10-⁶ mol/g and less than or equal to about 3000 × 10⁻⁶ mol/g.

7. The composite particle of claim 1, wherein
an amount of desorbed C₆H₆ (MS5) of the composite particle from about 80° C. to about 1400° C. by TDS-MS is greater than or equal to about 1 × 10 ⁻⁶ mol/g and less than or equal to about 4000 × 10-⁶ mol/g.

8. The composite particle of claim 1, wherein
the metal hydroxide particles comprise at least one selected from among aluminum hydroxide, pseudo-boehmite, boehmite, alumina, and kaolinite.

9. A positive electrode for a non-aqueous electrolyte rechargeable battery, the positive electrode comprising a positive electrode mixture layer comprising:
a plurality of composite particles each being in the form of the composite particle according to claim 1, the composite particles being in a range of greater than or equal to about 0.1 wt% and less than or equal to about 5.0 wt% based on a total weight, 100 wt%, of the positive electrode mixture layer.

10. A negative electrode for a non-aqueous electrolyte rechargeable battery, the negative electrode comprising a negative electrode mixture layer comprising:
a plurality of composite particles each being in the form of the composite particle according to claim 1, the composite particles being in a range of greater than or equal to about 0.1 wt% and less than or equal to about 5.0 wt% based on a total weight, 100 wt%, of the negative electrode mixture layer.

11. A non-aqueous electrolyte rechargeable battery, comprising
a positive electrode, a negative electrode, a separator, and a non-aqueous electrolyte,
wherein the positive electrode is the positive electrode of claim 9.

12. A non-aqueous electrolyte rechargeable battery, comprising
a positive electrode, a negative electrode, a separator, and a non-aqueous electrolyte,
wherein the negative electrode is the negative electrode of claim 10.

13. A method for producing composite particles for a non-aqueous rechargeable electrolyte battery, comprising
mixing a raw material of metal hydroxide particles and conductive particles while heating to form a first composite particle of the metal hydroxide particles and the conductive particles, and
modifying the first composite particle utilizing a treatment agent.

14. The method of claim 13, wherein
the treatment agent comprises at least one of phosphoric acid, phosphonic acid, or phosphinic acid.

15. The method of claim 13, wherein
the raw material of the metal hydroxide particles and the conductive particles are mixed by spray-drying while heating.
